(19) United States
(12) Patent Application Publication
(10) Pub. No.: US 2023/0205553 A1
(43) Pub. Date: Jun. 29, 2023

(54) METHOD, SYSTEM, ELECTRONIC DEVICE, MEDIUM AND PROGRAM PRODUCT FOR USER INTERFACE PROCESSING

(71) Applicant: Beijing Zitiao Network Technology Co., Ltd., Beijing (CN)

(72) Inventor: Jie YANG, Beijing (CN)

(21) Appl. No.: 18/057,826

(22) Filed: Nov. 22, 2022

(30) Foreign Application Priority Data
Dec. 28, 2021 (CN) 202111624084.2

(51) Int. Cl. G06F 9/451; G06F 9/54

(52) U.S. Cl. CPC G06F 9/451; G06F 9/542

(57) ABSTRACT

The present application relates to a method, system, electronic device, medium and program product for user interface processing, which are applied in the field of computer technology. The present disclosure enables: periodically acquiring user interface events for a target application based on an event loop mechanism; using a scripting language, processing the user interface events acquired in each period to perform frame refreshing on the user interface of the target application.

### CROSS REFERENCE TO RELATED APPLICATIONS

This application is based on and claims priority of CN application with application No. 202111624084.2 filed on Dec. 28, 2021, the entire disclosure of which is hereby incorporated by reference.

### TECHNICAL FIELD

The present application relates to the field of computer technology, and in particular, to a method, system, electronic device, medium and program product for user interface processing.

### BACKGROUND

At present, UI (User Interface) frameworks that can implement frame looping include IMGUI (real-time rendering UI implemented in C/C++ language) and Electron, etc.

### SUMMARY

The present application provides a method, system, electronic device, medium and program product for user interface processing.

According to a first aspect of the present application, there is provided a method for user interface processing, comprising:
based on an event loop mechanism, periodically acquiring user interface events for a target application;
using a scripting language, processing the user interface events acquired in each period to perform frame refreshing on the user interface of the target application.

Optionally, the processing the user interface events acquired in each period to perform frame refreshing on the user interface of the target application comprises:
semantically processing the user interface events acquired in each period to obtain target events that are independent of the types of operating systems;
processing the target events to perform frame refreshing on the user interface of the target application.

Optionally, the processing the user interface events acquired in each period comprises:

for each period, if the number of user interface events received in the period is more than one, after receiving each user interface event, processing the user interface event.

Optionally, the periodically acquiring user interface events for a target application comprises:

when a timing period of a timer arrives, acquiring the user interface events for the target application, wherein the next timing period is determined based on the processing duration corresponding to the user interface events within the previous timing period.

Optionally, the processing the user interface events acquired in each period comprises:
determining an event type of a single user interface event acquired in each period;
processing the user interface event in a processing manner corresponding to the event type.

Optionally, the event type includes: a window type and a non-window type;
the processing the user interface event in a processing manner corresponding to the event type comprises:
if the event type of a single user interface event is a window type, processing the user interface event through an event system;
if the event type of a single user interface event is a non-window type, processing the user interface event through an entity corresponding to the user interface event.

Optionally, the method further comprises:
acquiring target user interface events for one or more types of operating systems;
performing personalized processing on the target user interface events for the one or more types of operating systems.

Optionally, the event loop mechanism includes a node.js based event loop mechanism or an application development framework based event loop mechanism.

According to a second aspect of the present application, there is provided a system for user interface processing, comprising: an operating system module, a platform module, and a scripting module supporting scripting languages;
The platform module is configured to periodically acquire user interface events for a target application from the operating system module based on an event loop mechanism, and distribute the user interface events acquired in each period to the scripting module;
The scripting module is configured to process the received user interface events by using a scripting language, to perform frame refreshing on the user interface of the target application.

Optionally, the platform module is further configured to semantically process the user interface events acquired in each period to obtain target events that are independent of the types of operating systems;
The platform module is specifically configured to distribute the target events to the scripting module;
The scripting module is specifically configured to process the received target events, to perform frame refreshing on the user interface of the target application.

Optionally, for each period, if the number of user interface events received by the scripting module in the period is more than one, the scripting module is specifically configured to, after receiving each user interface event, process the user interface event.

Optionally, the platform module is specifically configured to, when a timing period of a timer arrives, acquire the user interface events for the target application, wherein the next timing period is determined based on the processing duration corresponding to the user interface events within the previous timing period.

Optionally, the platform module is specifically configured to distribute a single user interface event acquired in each period to a processing unit corresponding to the event type in the scripting module according to the event type of the single user interface event;

The scripting module is specifically configured to process the user interface events through a processing unit corresponding to the event type.

Optionally, the event type includes: a window type and a non-window type;
The scripting module is specifically configured to, if the event type of a single user interface event is a window type, process the user interface event through a event system in the scripting module;
if the event type of a single user interface event is a non-window type, process the user interface event through an entity corresponding to the user interface event in the scripting module.

Optionally, the platform module includes a personalization unit corresponding to one or more types of operating systems, and the personalization unit is configured to acquire target user interface events of corresponding types of operating systems; and perform personalized processing on the target user interface events.

Optionally, the event loop mechanism includes a node.js based event loop mechanism or an application development framework based event loop mechanism.

According to a third aspect of the present application, there is provided an electronic device, comprising: a memory and a processor, wherein the memory is configured to store a computer program; the processor is configured to execute the computer program, and when the computer program is executed by the processor, implements the method of the first aspect.

According to a fourth aspect of the present application, there is provided a non-transitory computer-readable storage medium having a computer program stored thereon, which, when executed by a processor, implements the method of the first aspect.

According to a fifth aspect of the present application, there is provided a computer program product, which, when runs on a computer, causes the computer to perform the method of the first aspect.

### BRIEF DESCRIPTION OF THE DRAWINGS

The accompanying drawings, which are incorporated in and constitute a part of this specification, illustrate embodiments consistent with the present application and serve to explain principles of the application together with the specification.

In order to more clearly illustrate technical solutions in the embodiments of the present application or the related technique, the accompanying drawings that need to be used in the description of the embodiments or the related technique will be introduced briefly follow. Apparently, for those of ordinary skilled in the art, other drawings can also be obtained from these drawings without any creative effort.

FIG. 1 is a schematic diagram of realizing frame cycle based on event cycle in an embodiment of the application;

FIG. 2 is an overall flow chart of realizing frame cycle in an embodiment of the application;

FIG. 3 is a flowchart of a method for user interface processing in an embodiment of the present application;

FIG. 4 is a schematic architectural diagram of a system for user interface processing in an embodiment of the present application;

FIG. 5 is a schematic diagram of user interface event delivery in an embodiment of the present application;

FIG. 6 is a schematic diagram of user interface event distribution in an embodiment of the present application;

FIG. 7 is a schematic diagram of a platform module in an embodiment of the application;

FIG. 8 is a schematic structural diagram of an electronic device in an embodiment of the present application.

### DETAILED DESCRIPTION

In order to more clearly understand above objects, features and advantages of the present application, the solution of the present application will be further described below. It should be noted that embodiments of the present application and features in the embodiments may be combined with each other without conflict.

Many specific details are set forth in the following description to facilitate a full understanding of the present application, but the present application can also be implemented in other ways different from those described herein; obviously, the embodiments in the specification are only a part, not all, of embodiments of the present application.

IMGUI does not support scripting languages well as a development language; Electron does support scripting languages, but more common scenarios are event-driven non-frame refreshing. Therefore, there is lack of a UI framework that supports both scripting languages and frame refreshing.

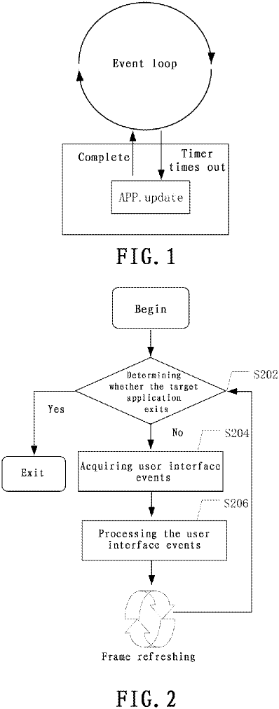

Referring to FIG. 1, FIG. 1 is a schematic diagram of realizing frame cycle based on event cycle in an embodiment of the present application. As shown in FIG. 1, frame cycle of a UI framework can be realized by using existing event loop mechanism. The event loop refers to that in the UI framework, user interface events triggered by a user can be continuously acquired, and the acquired user interface events can be processed. It can be understood that the event loop can continue to proceed in the case that a target application does not exit, and the event loop ends in the case that the target application exits. Under the event loop mechanism, the frame loop of the UI framework is realized by periodically acquiring user interface events and processing the user interface events.

Referring to FIG. 2, FIG. 2 is an overall flow chart of realizing frame cycle in an embodiment of the application, that is, the flow chart corresponding to APP.update in FIG. 1. After a timer times out, the flow starts and performs following steps sequentially:

Step S202, determining whether the target application exits, if the target application exits, the flow exits directly, otherwise, following step S204 is performed.

Step S204, acquiring user interface events.

Step S206, processing the user interface events to implement frame refreshing. When the next cycle arrives, step S202 is performed again. Through above process, the frame cycle is realized.

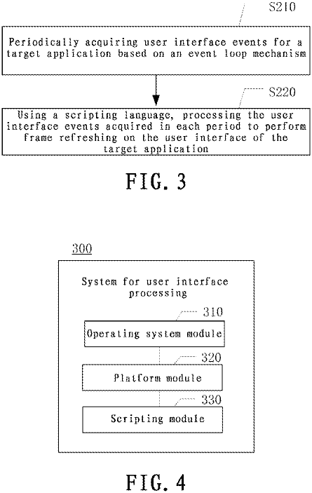

Referring to FIG. 3, FIG. 3 is a flowchart of a method for user interface processing in an embodiment of the present application, which may include following steps:

Step S210, periodically acquiring user interface events for a target application based on an event loop mechanism.

Step S220, using a scripting language, processing the user interface events acquired in each period to perform frame refreshing on the user interface of the target application.

The method for user interface processing of the embodiment of the present application, under the event loop mechanism, periodically acquires user interface events for a target application, and processes the user interface events acquired in each period by using a scripting language, so as to realize the design of frame loop. As it can be seen, the method for user interface processing of the present application can implement frame refreshing while supporting scripting languages. And scripting languages are lighter and more extensible than languages such as C++, Java, so the efficiency of code development can be improved.

The method for user interface processing according to the embodiment of the present application will be described in more detail below.

In step S210, based on an event loop mechanism, user interface events for a target application are periodically acquired.

In the UI framework, a user performs corresponding operations on the target application and can generate corresponding user interface events. The application can maintain a message queue. When an operation for the target application is received, corresponding user interface event can be put into the message queue, and other operations may continue to be received. Also, user interface events can be acquired from the message queue and processed. When the target application exits, there will be no new user interface events and the event loop ends. Optionally, the event loop mechanism includes a node.js based event loop mechanism or an application development framework based event loop mechanism.

In an embodiment of the present application, a timer may be started for periodically acquiring user interface events for a target application. When a timing period of the timer arrives, the user interface events for the target application are acquired. For example, with a timing period of 30 milliseconds, the timer can be triggered every 30 milliseconds, which will acquire user interface events for the target application every 30 milliseconds.

If durations for processing user interface events are all less than the timing period, and the timing period of the timer remains unchanged, the entire frame can be guaranteed to be stable. For example, each timing period is 30 milliseconds. However, in actual cases, the durations for processing user interface events may be longer than the timing period, such as 40 milliseconds. At this time, when the timing period arrives, the processing of user interface events has not been completed, thus acquisition of new user interface events cannot be triggered.

Therefore, in some embodiments, the next timing period may be determined based on the processing duration corresponding to the user interface events within the previous timing period. For example, if the timing period is 30 milliseconds, and the processing duration for the user interface events is 40 milliseconds, the next timing period can be adjusted to be 20 milliseconds to compensate for this time difference, so that the entire frame can be guaranteed to be stable.

In step S220, using a scripting language, processing the user interface events acquired in each period to perform frame refreshing on the user interface of the target application.

The UI framework of the present application can support scripting languages, which are lighter and more extensible than other languages (such as C language and JAVA language). Therefore, using scripting languages to process user interface events can improve the efficiency of code development.

In some embodiments, the user interface events acquired in each period may be semantically processed to obtain target events that are independent of the types of operating systems, and the target events may be processed to perform frame refreshing on the user interface of the target application. In this way, by building a cross-platform UI framework, developers can obtain UI results that conform to platform interaction on different platforms by writing a script without needing to perceive the type of the operating system.

A user may trigger multiple operations on the target application within a timing period, and each operation corresponds to a user interface event. In related art, the user interface event is processed after all user interface events are received. While user interface events corresponding to certain operations are continuously generated. For example, when the user zooms on the screen, the user may keep scrolling the mouse, and user interface events cannot be received, and thus the user interface events cannot be processed.

Based on this, for each period, if the number of user interface events received in the period is more than one, each user interface event is processed after the user interface event is received. That is, each time a user interface event is received, the user interface event is processed, instead of processing user interface event after all user interface events are received in each timing period, so as to avoid the problem that frame refreshing cannot be done.

In the UI framework, the user interface events may include different event types, and if event types of the user interface events are different, manners for processing the user interface events may also be different. The event type of a single user interface event acquired in each period may be determined first, and then the user interface event is processed through a processing manner corresponding to the event type.

In some embodiments, the event type includes: a window type and a non-window type. If the event type of a single user interface event is a window type, for example, the event type of mouse event, keyboard type, scroll event, etc. is a window type, the user interface event can be processed through an event system. Wherein, the event system refers to a system for processing user interface events of a window type. If the event type of a single user interface event is a non-window type, for example, the event type of a color dialog box event, file dialog box event, application program event, etc. is a non-window event, the user interface event can be processed through an entity corresponding to the user interface event.

The UI framework of the embodiments of the present application can not only implement cross-platform, but also implement functions specific to different operating systems in a personalized manner. In some embodiments, target user interface events of one or more types of operating systems may be acquired, and personalized processing may be performed on the target user interface events of one or more types of operating systems. The target user interface events refer to events used for personalized processing, which may be preset user interface events.

For example, for a target user interface event acquired from Windows operating system and a target user interface event acquired from MAC operating system, even if the two target user interface events are the same event, they can be processed differently.

In the method for user interface processing of the embodiment of the present application, under the event loop mechanism, after user interface events for a target application are periodically acquired, semantic processing can be performed on the user interface events, so that the processed target events are independent of the types of operating systems, and developers do not need to perceive the types of the operating systems, and can obtain UI results that conform to platform interaction on different platforms by writing a script, that is, implement a cross-platform UI framework. As it can be seen, the method for user interface processing of the present application can implement frame loop while supporting scripting languages, and supports cross-platform, so the efficiency of development can be improved.

FIG. 4 is a schematic structural diagram of a system for user interface processing in an embodiment of the present application. As shown in FIG. 4, the system for user interface processing 300 comprises: an operating system module 310, a platform module 320 and a scripting module 330 supporting scripting languages.

The operating system module 310 refers to a module that directly interacts with the operating system. When a user operates on a user interface of a target application, the operating system module 310 can generate corresponding user interface events.

The platform module 320 is an abstract module that can encapsulate the acquired user interface events and send them to the scripting module 330.

The scripting module 330 is a module that supports scripting languages and can process user interface events. Developers can develop the scripting module 230 with scripting languages. Since scripting languages are lighter and more extensible than languages such as C++ and Java, it is easier for developers to get started. After the scripting module 330 receives a user interface event, it can process the user interface event through an internal event processing function.

In the system for user interface processing 300:

The platform module 320 is configured to periodically acquire user interface events for a target application from the operating system module 310 based on an event loop mechanism, and send the user interface events acquired in each period to the scripting module 330.

The scripting module 330 is configured to process the received user interface events by using a scripting language, to perform frame refreshing on the user interface of the target application.

The system for user interface processing of the embodiment of the present application, under the event loop mechanism, periodically acquires user interface events for a target application, and processes the user interface events through a scripting module supporting scripting languages, so as to realize the design of frame loop. As it can be seen, the system for user interface processing of the present application can implement frame refreshing while supporting scripting languages. And scripting languages are lighter and more extensible than languages such as C++, Java, so the efficiency of code development can be improved.

The system for user interface processing in the embodiment of the present application will be introduced in more detail below.

The platform module 320 is configured to periodically acquire user interface events for a target application from the operating system module 210 based on an event loop mechanism, and send the user interface events acquired in each period to the scripting module 330.

In the embodiment of the present application, the event loop mechanism may include a node.js based event loop mechanism or an application development framework based event loop mechanism. Wherein, node.js is a JavaScript runtime environment based on the Chrome V8 engine, using an event-driven, non-blocking I/O (input/output) model. Node.js supports scripting languages, such as js/ts/tsx2, etc.

The platform module 320 may periodically acquire user interface events for a target application from the operating system module 310 based on an event loop mechanism. For example, the platform module 320 may acquire user interface events for the target application from the operating system module 310 every 30 milliseconds. After acquiring the user interface events, the platform module 320 can send the user interface events to the scripting module 330 to process the user interface events through the scripting module 330.

Optionally, periodically acquiring user interface events for a target application from the operating system module 310 may be realized via a timer. The platform module 320 is specifically configured to acquire user interface events for the target application when the timing period of the timer arrives. For example, the timing period of the timer is set to 30 milliseconds, and every 30 milliseconds elapses, and the timing period arrives, then user interface events for the target application are acquired.

It can be understood that, if durations for processing user interface events are all less than the timing period, the timing period of the timer may remain unchanged. For example, each timing period is 30 milliseconds. However, in actual cases, the durations for processing user interface events may be longer than the timing period, such as 40 milliseconds. At this time, when the timing period arrives, the processing of user interface events has not been completed, thus acquisition of new user interface events cannot be triggered.

In order to solve this problem, the next timing period may be determined based on the processing duration corresponding to the user interface events within the previous timing period. For example, if the timing period is 30 milliseconds, and the processing duration for the user interface events is 40 milliseconds, the next timing period can be 20 milliseconds to compensate for this time difference, so that the entire frame can be guaranteed to be stable.

The scripting module 330 is configured to process the received user interface events by using a scripting language, to perform frame refreshing on the user interface of the target application.

It can be understood that a user may trigger multiple operations within a timing period, and each operation corresponds to a user interface event. In related art, the user interface event is processed after all user interface events are received. While user interface events corresponding to certain operations are continuously generated. For example, when the user zooms on the screen, the user may keep scrolling the mouse, and the user interface events cannot be received, and thus the user interface events cannot be processed.

Based on this, for each period, if the number of user interface events received by the scripting module 330 in the period is more than one, the scripting module 330 is specifically configured to, process each user interface event after the user interface event is received. That is, each time a user interface event is received, the user interface event is processed, instead of processing the user interface event after all user interface events are received in each timing period, so as to avoid the problem that frame refreshing cannot be done.

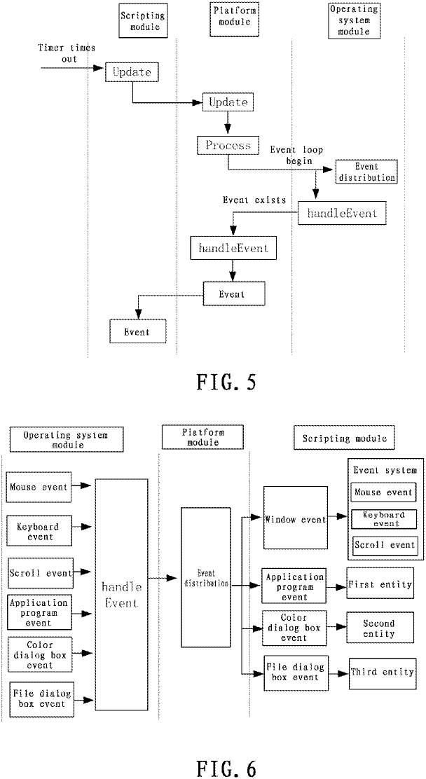

Referring to FIG. 5, FIG. 5 is a schematic diagram of user interface event delivery in an embodiment of the present application. As described above, when the timer times out, App.update may be triggered. For App.update, the update of the scripting module 330 can be first entered, and then the update of the platform module 320 can be entered, and user interface events are acquired from an event dispatching unit of the operating system module through a process function of an event dispatching unit of the platform module 320. It should be noted that, for different types of operating systems, user interface events may be acquired from event dispatching units of different types of operating system modules. For example, for the Windows operating system, user interface events may be acquired from the event dispatching unit of the Windows operating system; for the MAC operating system, user interface events may be acquired from the event dispatching unit of the MAC operating system.

In the embodiment of the present application, the platform module 320 is further configured to semantically process the user interface events acquired in each period to obtain target events that are independent of the types of operating systems. The scripting module 330 is specifically configured to process the received target events, so as to perform frame refreshing on the user interface of the target application. That is, by building a cross-platform UI framework, developers can acquire UI results that conform to platform interaction on different platforms by writing a script without needing to perceive the type of operating system. As shown in FIG. 5, the handleEvent of the event dispatching unit of the platform module 320 can perform semantic processing on user interface events, so that the processed target events conform to events of the UI framework.

As an example, the origin coordinates of the Windows operating system are in the upper left corner of the screen, while the origin coordinates of the MAC operating system are in the lower left corner of the screen. As it can be seen, there is a difference for the definition to the left of the origin between the two operating systems. Accordingly, the same position of the mouse on the screen corresponds to different position coordinates. In order to unify two different operating systems, two different position coordinates can be converted into the same position coordinate through coordinate transformation. For example, the position coordinates of the origin in the two operating systems can be unified into the center position of the screen through coordinate transformation. Developers only need to know that the coordinates of the center position of the screen are the coordinates of the origin, and make development based on this, without the need to make different developments in accordance with different operating systems.

Afterwards, the platform module 320 sends the target events to the scripting module 330. The platform module 320 is specifically configured to send a single user interface event acquired in each period to a processing unit corresponding to the event type in the scripting module 330 according to the event type of the single user interface event. The scripting module 330 is specifically configured to process the user interface event through the processing unit corresponding to the event type.

Optionally, the event type includes: a window type and a non-window type; the scripting module 330 is specifically configured to process the user interface event through an event system in the scripting module 330 if the event type of a single user interface event is a window type; and process the user interface event through an entity corresponding to the user interface event in the scripting module 330 if the event type of the single user interface event is a non-window type.

Referring to FIG. 6, FIG. 6 is a schematic diagram of user interface event distribution in an embodiment of the application. The handleEvent of the operating system module 310 can acquire different user interface events, such as mouse events, keyboard types, scroll events, color dialog box events, file dialog box events, application program events, etc.

There are many UI controls drawn by scripts on the window entity. For user interface events of window type (such as mouse events, keyboard types, scroll events, etc.), the user interface events can be sent to the event system in the scripting module 330. The event system further send the user interface events to corresponding UI elements, which will process the user interface events.

For color dialog box events, file dialog box events, application program events, etc., since there is no UI control drawn by scripts on the window entity, the user interface events can be directly sent to corresponding entities in the scripting module 330, which will process the user interface events.

In an embodiment of the present application, the platform module 320 can implement functions specific to different operating systems in a personalized manner, in addition to semantically processing user interface events of individual operating systems. Optionally, the platform module 320 includes a personalization unit corresponding to one or more types of operating systems respectively, and the personalization unit is configured to acquire target user interface events of corresponding type of operating system, and to perform personalized processing on the target user interface events.

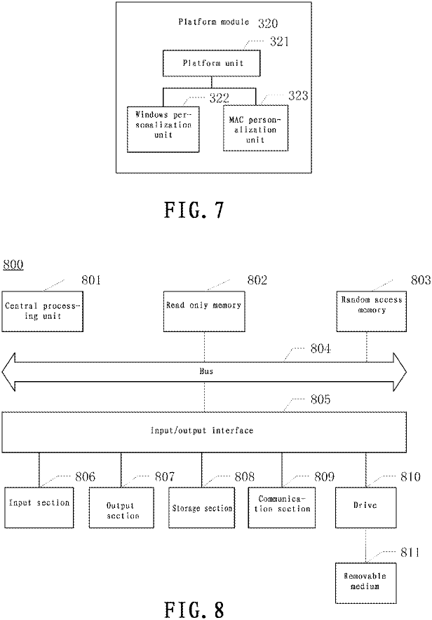

Referring to FIG. 7, FIG. 7 is a schematic diagram of a platform module in an embodiment of the present application. The platform module 320 may include a platform unit 321, a Windows personalization unit 322, and a MAC personalization unit 323. It is assumed that the platform unit 321 can perform semantic processing on user interface events of different operating systems, that is, the platform unit 321 implements a cross-platform UI framework, then the Windows personalization unit 322 and the MAC personalization unit 323 can integrate all features of the platform unit 321, and can also have more unique other features. It can be understood that the platform module 320 can contain as many personalization units as there are types of operating systems. It should be noted that each personalization unit is detachable. For example, if the functionality of Windows is intended to be uninstalled, the Windows personalization unit 322 can be directly deleted.

The system for user interface processing of the embodiment of the present application, under an event loop mechanism, after the platform module periodically acquires user interface events for a target application, can perform semantic processing on the user interface events, so that the processed target events are independent of the types of operating systems. Developers can obtain UI results that conform to platform interaction on different platforms by writing a script without needing to perceive the type of the operating system, that is, a cross-platform UI framework is realized. The platform module can also distribute the user interface events to different entities of the scripting module according to the types of the user interface events, and process the user interface events through different entities. As it can be seen, the system for user interface processing of the present application can implement frame looping while supporting scripting languages, and support cross-platform, so that the efficiency of development can be improved.

It should be noted that although several modules or units of the device for action performance are mentioned in above detailed description, this kind of division is not mandatory. Indeed, according to implementations of the present application, features and functions of two or more modules or units described above may be embodied in one module or unit. Conversely, features and functions of one module or unit described above may be further divided into multiple modules or units to be embodied.

In an exemplary embodiment of the present application, there is also provided an electronic device, comprising: a processor; a memory for storing instructions executable by the processor; wherein the processor is configured to execute above method for user interface processing in the present example implementation.

FIG. 8 is a schematic structural diagram of an electronic device in an embodiment of the present application. It should be noted that the electronic device 800 shown in FIG. 8 is only an example, and should not impose any limitations on functions and scope of use of the embodiments of the present application.

As shown in FIG. 8, the electronic device 800 includes a central processing unit (CPU) 801 that perform various appropriate actions and processes according to a program stored in a read only memory (ROM) 802 or a program loaded into a random access memory (RAM) 803 from a storage section 808. In the RAM 803, various programs and data necessary for system operation are also stored. The central processing unit 801, the ROM 802 and the RAM 803 are connected to each other via a bus 804. An input/output (I/O) interface 805 is also connected to the bus 804.

The following components are connected to the I/O interface 805: an input section 806 including a keyboard, a mouse, etc.; an output section 807 including such as a cathode ray tube (CRT), a liquid crystal display (LCD), etc., and a speaker, etc.; a storage section 808 including a hard disk, etc.; and a communication section 809 including network interface cards such as local area network (LAN) cards, modems, and the like. The communication section 809 performs communication processing via a network such as the Internet. A drive 810 is also connected to the I/O interface 805 as needed. A removable medium 811, such as a magnetic disk, an optical disk, a magneto-optical disk, a semiconductor memory, etc., is mounted on the drive 810 as needed so that a computer program read therefrom is installed into the storage section 808 as needed.

In particular, according to an embodiment of the present application, the processes described above with reference to the flowcharts may be implemented as computer software programs. For example, an embodiment of the present application includes a computer program product comprising a computer program carried on a computer-readable medium, the computer program containing program code for performing the methods illustrated in the flowcharts. In such an embodiment, the computer program may be downloaded and installed from the network via the communication portion 809 and/or installed from the removable medium 811. When the computer program is executed by the central processing unit 801, various functions defined in the system of the present application are performed.

In an embodiment of the present application, there is also provided a non-transitory computer-readable storage medium, on which a computer program is stored, which, when executed by a processor, implement above method for user interface processing.

It should be noted that the non-transitory computer-readable storage medium shown in the application can be, for example, but not limited to, an electrical, magnetic, optical, electromagnetic, infrared, or semiconductor system, apparatus or device, or any combination thereof. More specific examples of computer readable storage media may include, but not limited to, an electrical connection with one or more wires, a portable computer disk, a hard disk, a random access memory, a read only memory, an erasable programmable read only memory (EPROM or flash memory), an optical fiber, a portable compact disk read only memory (CD-ROM), an optical storage device, a magnetic storage device, or any suitable combination thereof. In this application, a non-transitory computer-readable storage medium can be any tangible medium that contains or stores a program that can be used by or in conjunction with an instruction execution system, apparatus, or device. The program code contained on the non-transitory computer-readable storage medium may be transmitted using any suitable medium, including but not limited to, wireless, wire, optical cable, Radio Frequency, etc., or any suitable combination thereof.

In an embodiment of the present application, there is also provided a computer program product, which, when run on a computer, causes the computer to execute above method for user interface processing.

It should be noted that, in this document, relational terms such as “first” and “second” etc. are only used to distinguish one entity or operation from another entity or operation, and do not necessarily require or imply there is any such actual relationship or sequence between these entities or operations. Moreover, the terms “comprise”, “include” or any other variations thereof are intended to encompass a non-exclusive inclusion such that a process, method, article or device that includes a range of elements comprises not only those elements, but also comprises other elements not explicitly listed, or elements inherent to such a process, method, article or device. Without further limitation, an element defined by the phrase “comprising one...” does not preclude the presence of additional identical elements in the process, method, article or device comprising the element.

Above descriptions are only specific implementations of the present application, to enable those skilled in the art to understand or implement the present application. Various modifications to these embodiments will be readily apparent to those skilled in the art, and the generic principles defined herein may be implemented in other embodiments without departing from the spirit or scope of the present application. Therefore, this application is not intended to be limited to the embodiments described herein, but is to be accorded the widest scope consistent with the principles and novel features disclosed herein.

What is claimed is:

1. A method for user interface processing, the method comprises:
based on an event loop mechanism, periodically acquiring user interface events for a target application; and
using a scripting language, processing the user interface events acquired in each period to perform frame refreshing on the user interface of the target application.

2. The method according to claim 1, wherein the processing the user interface events acquired in each period to perform frame refreshing on the user interface of the target application comprises:
semantically processing the user interface events acquired in each period to obtain target events that are independent of the types of operating systems; and
processing the target events to perform frame refreshing on the user interface of the target application.

3. The method according to claim 1, wherein the processing the user interface events acquired in each period comprises:
for each period, if the number of user interface events received in the period is more than one, after receiving each user interface event, processing the user interface event.

4. The method according to claim 1, wherein the periodically acquiring user interface events for a target application comprises:
when a timing period of a timer arrives, acquiring the user interface events for the target application, wherein the next timing period is determined based on the processing duration corresponding to the user interface events within the previous timing period.

5. The method according to claim 1, wherein the processing the user interface events acquired in each period comprises:
determining an event type of a single user interface event acquired in each period; and
processing the user interface event in a processing manner corresponding to the event type.

6. The method according to claim 5, wherein the event type includes: a window type and a non-window type;
the processing the user interface event in a processing manner corresponding to the event type comprises:
if the event type of a single user interface event is a window type, processing the user interface event through an event system; and
if the event type of a single user interface event is a non-window type, processing the user interface event through an entity corresponding to the user interface event.

7. The method of claim 1, wherein the method further comprises:
acquiring target user interface events for one or more types of operating systems; and
performing personalized processing on the target user interface events for the one or more types of operating systems.

8. The method according to claim 1, wherein the event loop mechanism includes a node.js based event loop mechanism or an application development framework based event loop mechanism.

9. A system for user interface processing, comprising: an operating system module, a platform module, and a scripting module supporting scripting languages;
the platform module is configured to periodically acquire user interface events for a target application from the operating system module based on an event loop mechanism, and distribute the user interface events acquired in each period to the scripting module;
the scripting module is configured to process the received user interface events by using a scripting language, to perform frame refreshing on the user interface of the target application.

10. An electronic device, comprising: a memory and a processor, wherein the memory is configured to store a computer program; the processor is configured to execute the computer program, and when the computer program is executed by the processor, implements a method comprising:
based on an event loop mechanism, periodically acquiring user interface events for a target application; and
using a scripting language, processing the user interface events acquired in each period to perform frame refreshing on the user interface of the target application.

11. The electronic device according to claim 10, wherein the processor is configured to execute the computer program, which when executed by the processor, implements the method further comprising:
semantically processing the user interface events acquired in each period to obtain target events that are independent of the types of operating systems; and
processing the target events to perform frame refreshing on the user interface of the target application.

12. The electronic device according to claim 10, wherein the processor is configured to execute the computer program, which when executed by the processor, implements the method further comprising:
for each period, if the number of user interface events received in the period is more than one, after receiving each user interface event, processing the user interface event.

13. The electronic device according to claim 10, wherein the processor is configured to execute the computer program, which when executed by the processor, implements the method further comprising:
when a timing period of a timer arrives, acquiring the user interface events for the target application, wherein the next timing period is determined based on the processing duration corresponding to the user interface events within the previous timing period.

14. The electronic device according to claim 10, wherein the processor is configured to execute the computer program, which when executed by the processor, implements the method further comprising:
determining an event type of a single user interface event acquired in each period; and
processing the user interface event in a processing manner corresponding to the event type.

15. The electronic device according to claim 14, wherein the event type includes: a window type and a non-window type, and the processor is configured to execute the computer program, which when executed by the processor, implements the method further comprising:
the processing the user interface event in a processing manner corresponding to the event type comprises:
if the event type of a single user interface event is a window type, processing the user interface event through an event system; and
if the event type of a single user interface event is a non-window type, processing the user interface event through an entity corresponding to the user interface event.

16. The electronic device according to claim 10, wherein the processor is configured to execute the computer program, which when executed by the processor, implements the method further comprising:
acquiring target user interface events for one or more types of operating systems; and
performing personalized processing on the target user interface events for the one or more types of operating systems.

17. The electronic device according to claim 10, wherein the event loop mechanism includes a node.js based event loop mechanism or an application development framework based event loop mechanism.

18. A non-transitory computer-readable storage medium having a computer program stored thereon, when the computer program is executed by a processor, implements the steps of the method for user interface processing according to claim 1.
